(19) United States
(12) Patent Application Publication
(10) Pub. No.: US 2021/0330998 A1
(43) Pub. Date: Oct. 28, 2021

(54) DISPOSABLE HEADGEAR

(71) Applicant: KUO-LIN LIN, Taichung City (TW)

(72) Inventor: KUO-LIN LIN, Taichung City (TW)

(21) Appl. No.: 17/227,390

(22) Filed: Apr. 12, 2021

(30) Foreign Application Priority Data
Apr. 23, 2020 (TW) 109204835

(51) Int. Cl. A62B 9/06; A41D 13/11; A62B 18/02; A62B 18/08

(52) U.S. Cl. CPC A62B 9/06; A41D 13/1161; A62B 18/084; A62B 18/02; A41D 13/1184

(57) ABSTRACT

The headgear includes a head piece with a front opening and a bottom opening fringed with a first strap. Two flat ear pieces are provided respectively and oppositely on two lateral sides of the head piece, each having an outward extended hook element. An eye piece and a mouth piece respectively seal an upper portion and a lower portion of the front opening. An upper rim of the mouth piece is joined to a lower rim of the eye piece. Two second straps run around the head piece, where two ends of an upper one and a lower one respectively join the four corners of the mouth piece. A sound amplifier is fixed to the mouth piece to facilitate wearer's verbal communication. The head piece may be made of PE for reducing cost and discomfort. An addition mask may be fastened to the ear pieces to enhance protection.

### BACKGROUND OF THE INVENTION

### (a) Technical Field of the Invention

The present invention is generally related to headgears, and more particular to a disposable headgear.

### (b) Description of the Prior Art

Due to the recent pandemics, there are various headgears provided as personal protection to prevent pathogens from transmitting among people. In addition to headgears, there are also people using face masks together with goggles.

For non-medical consumers, these headgears are often too expensive, and the constant replacement further make them costlier. Wearing a headgear also causes inconvenience, such as, eyeglasses fogging and the wearer's incapability of scratching. Using goggles and face masks is less effective and more uncomfortable. Additionally, as wearers' mouths are often covered, making verbal communications more difficult.

### SUMMARY OF THE INVENTION

A major objective of the present invention is to provide a disposable headgear of low cost and enhanced comfort when used over an extended period of time without compromising verbal communication.

To achieve the objective, the disposable headgear includes a head piece with a bottom opening fringed with a first strap and a front opening. Two flat ear pieces are configured respectively to two lateral sides of the head piece, corresponding to a wearer's ears. Each ear piece has an outward extending hook element. An eye piece seals an upper portion of the front opening, and a mouth piece seals a lower portion of the front opening. An upper rim of the mouth piece joins a lower rim of the eye piece. Two second strap run roughly in parallel around the head piece. The two ends of the upper second strap respectively join the upper left and right corners of the mouth piece, and the two ends of the lower second strap respectively join the lower left and right corners of the mouth piece. A sound amplifier is configured on the mouth piece.

The head piece may have a hollow bag body made of polyethylene (PE), so that it is flexible and not easy to crack. A wearer may still scratch through the head piece. The inside of the headgear is not foggy. The eye piece and the mouth piece may be integrally formed with the head piece for reduced production cost and enhanced protectivity.

Each of the first and second straps is an elastic band or rope. An additional mask may be applied and secured by the ear pieces' hook elements. The sound amplifier has a mesh structure made of rubber. The sound amplifier concentrates the wearer's voice to facilitate the wearer's verbal communication with other people.

The headgear is lightweight and the wearer would not feel any pressure. It is an inexpensive, disposable, long-lasting, medical protective gear ideal for occasions requiring protection over a long period of time, such as on long-distance transportation (e.g., airplane, train, bus), constant contact with a large number of people (e.g., behind bank or post office counters), or emergency medical care. Especially for medical personnel performing intubation, the present invention prevents the medical personnel's head or body from being splattered by patient's body fluid, therefore providing comprehensive protection. The headgear of the present invention can be put on and taken off conveniently. It may be disposed after use with no hazard and replaced by a new one.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a disposable headgear according to an embodiment of the present invention.

FIG. 2 is a perspective break-down diagram showing the disposable headgear of FIG. 1.

FIG. 3 is a perspective diagram showing an application scenario of the disposable headgear of FIG. 1.

FIG. 4 is a perspective diagram showing another application scenario of the disposable headgear of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

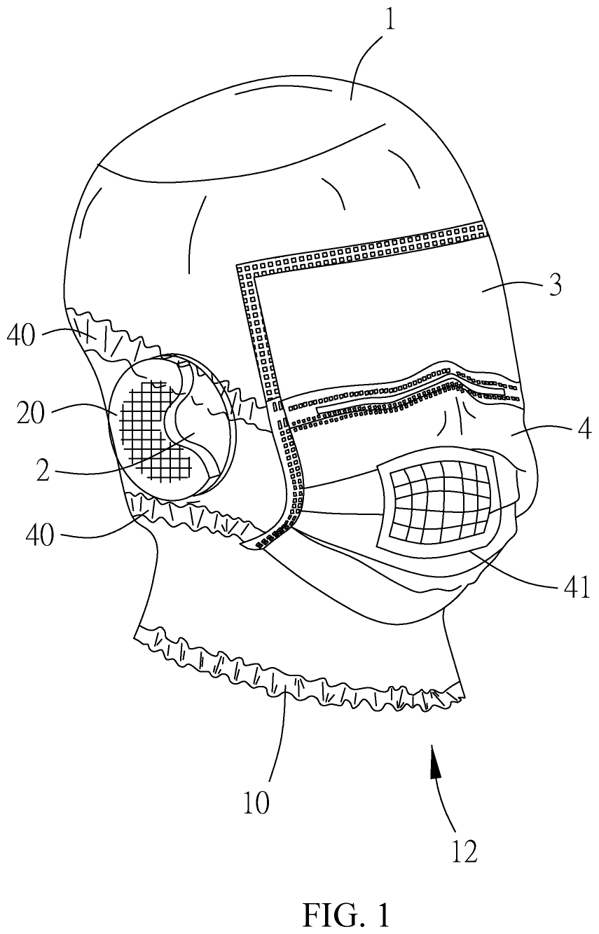

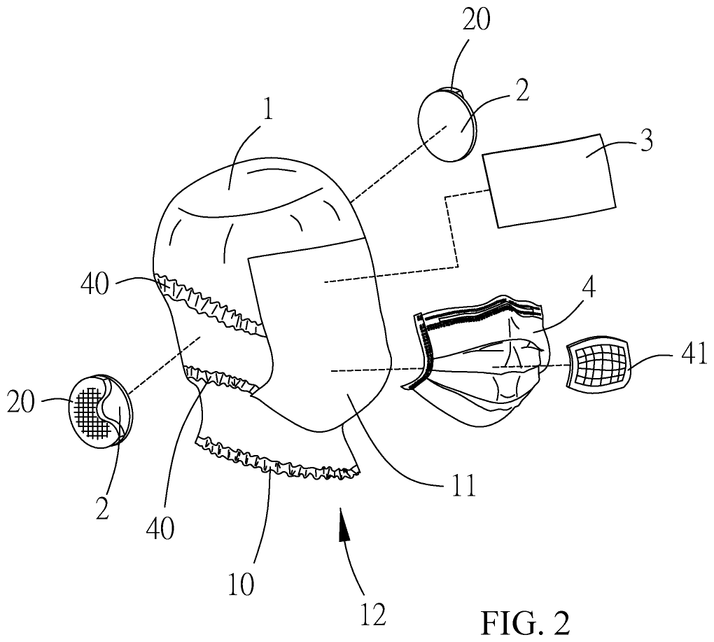

As shown in FIGS. 1 to 4, a disposable headgear according to an embodiment of the present invention includes a head piece 1 with a front opening 11 on a front side and a bottom opening 12 on a bottom side. The bottom opening 12 is fringed with a first strap 10. Two flat ear pieces 2 are provided respectively and oppositely on two lateral sides of the head piece 1, corresponding to a wearer's ears. Each ear piece 2 has an outward extended hook element 20, and a mesh structure in the center. An eye piece 3 seals an upper portion of the front opening 11. The eye piece 3 may be made of a transparent plastic material.

A mouth piece 4 seals a lower portion of the front opening 11. An upper rim of the mouth piece 4 is joined to a lower rim of the eye piece 3. Two second straps 40 run roughly in parallel around the head piece 1. The two ends of the upper second strap 40 respectively join the upper left and right corners of the mouth piece 4, and the two ends of the lower second strap 40 respectively join the lower left and right corners of the mouth piece 4. The mouth piece 4 may be structured like a conventional medical mask. A sound amplifier 41 may be fixed to an outer front side the mouth piece 4.

A wearer may slip the headgear over his or her head through the bottom opening 12 with the first strap 10 keeping the bottom opening 12 tightly around the wearer's neck so that no foreign object would enter the headgear. The second straps 40 attach the mouth piece 4 to the wearer's nose and mouth, and maintain the shape of the headgear when it is wrapped around the wearer's head. Each of the first and second straps is an elastic band or rope.

The head piece 1 may have a hollow bag body made of polyethylene (PE), so that it is waterproof, flexible, and not easy to crack. A wearer may still scratch through the head piece 1. The inside of the headgear is not sultry or foggy. The eye piece 3 and the mouth piece 4 may be integrally formed with the head piece 1 for reduced production cost and enhanced protectivity.

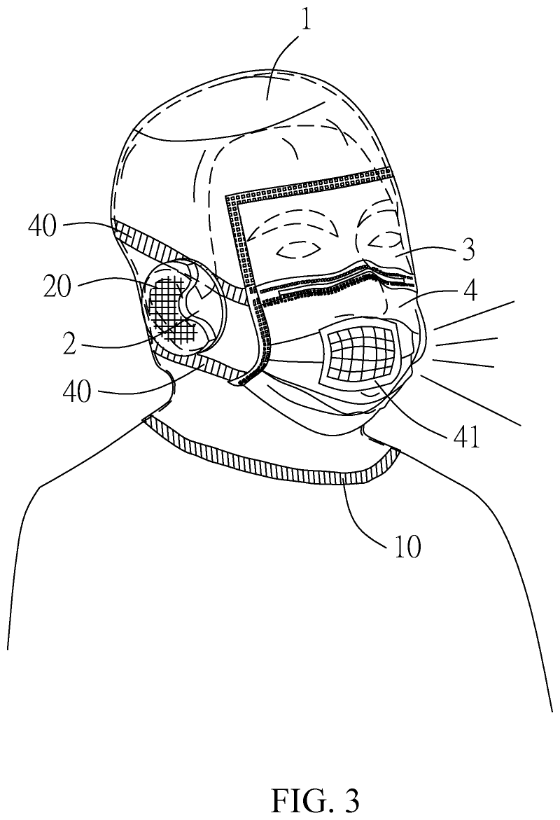

The mesh structure of each ear piece 2 provides unhindered sound transmission to the wearer's ears. The mesh structure may include a grid having multiple through holes. The sound amplifier 41 of the mouth piece 4 may also have a mesh structure made of rubber. The sound amplifier 41 allows ventilation and collects the wearer's voice for enhance clarity when the wearer converses with other people. As shown in FIG. 3, the wearer would experience no trouble during conversation with other people.

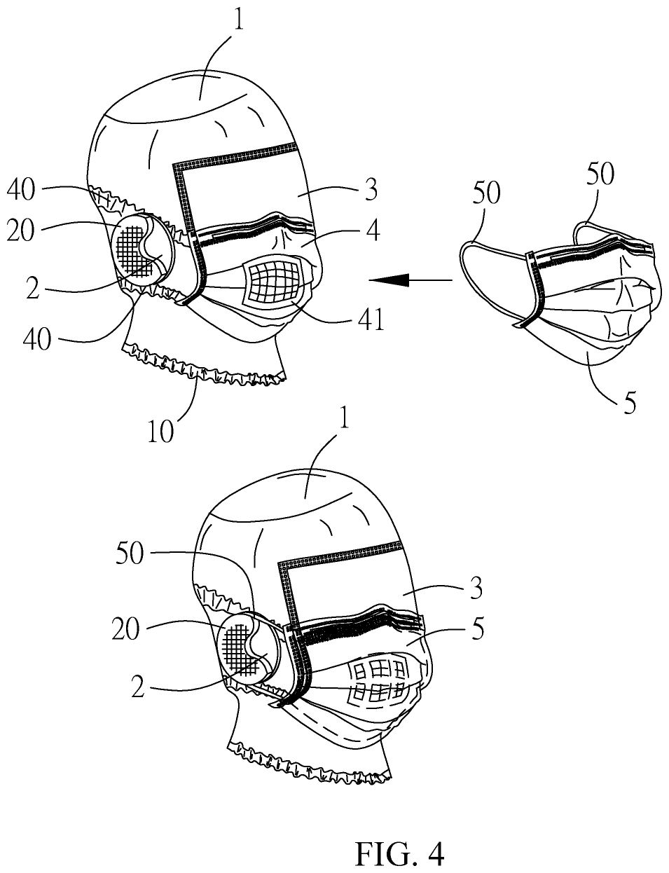

As shown in FIG. 4, a mask 5 may be further applied outside the mouth piece 4 with the mask 5's straps 50 respectively fastened to the hook elements 20 of the ear pieces 2. Due to the second straps 40 hold the head piece 1 from behind, the pull from the mask 5's straps 50 would not deform the headgear.

The headgear of the present invention is lightweight and the wearer would not feel any pressure. The headgear is an inexpensive, disposable, long-lasting, medical protective gear ideal for occasions requiring protection over a long period of time, such as on long-distance transportation (e.g., airplane, train, bus), constant contact with a large number of people (e.g., behind bank or post office counters), or emergency medical care. Especially for medical personnel performing intubation, the present invention prevents the medical personnel's head or body from being splattered by patient's body fluid, therefore providing comprehensive protection. The headgear of the present invention can be put on and taken off conveniently. It may be disposed after use with no hazard and replaced by a new one.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A disposable headgear, comprising:
a head piece with a front opening on a front side and a bottom opening on a bottom side, where the bottom opening is fringed with a first strap;
two flat ear pieces provided respectively and oppositely on two lateral sides of the head piece, corresponding to a wearer's ears, where each ear piece has an outward extended hook element and a mesh structure in the center;
an eye piece sealing an upper portion of the front opening;
a mouth piece sealing a lower portion of the front opening, where an upper rim of the mouth piece is joined to a lower rim of the eye piece;
two second straps running around the head piece, where two ends of an upper second strap respectively join the upper left and upper right corners of the mouth piece, and two ends of a lower second strap respectively join the lower left and lower right corners of the mouth piece; and
a sound amplifier fixed to an outer front side the mouth piece.

2. The disposable headgear according to claim 1, wherein the head piece has a hollow bag body made of polyethylene (PE).

3. The disposable headgear according to claim 1, wherein each of the first and second straps is an elastic band or elastic rope.

4. The disposable headgear according to claim 1, wherein the sound amplifier has a mesh structure made of rubber.
